(19) United States
(12) Patent Application Publication
(10) Pub. No.: US 2025/0344902 A1
(43) Pub. Date: Nov. 13, 2025

(54) SEMI-RIGID, MULTI-PLY, SILICONE DETACHABLE DRAIN TUBE FOR FRYERS AND OTHER COMMERCIAL COOKING EQUIPMENT AND METHODS OF USE

(71) Applicant: WS Holdings, LLC, Colleyville, GA (US)

(72) Inventors: James Ralph Wixson, Roswell, GA (US); Chad Corbett Wixson, Marietta, GA (US); Patrick Brusche Wixson, Marietta, GA (US); Todd Howard Wixson, Rogers, AR (US)

(21) Appl. No.: 19/046,715

(22) Filed: Feb. 6, 2025

Related U.S. Application Data
(60) Provisional application No. 63/646,116, filed on May 13, 2024.

(51) Int. Cl. A47J 37/12

(52) U.S. Cl. CPC A47J 37/1285

(57) ABSTRACT

A method for effectively draining edible cooking oil at up to 350 F (170 C) and other by-products of the frying process from commercial counter model, free standing or in-battery deep fat fryers, and other commercial cooking equipment such as; griddles, combi ovens, and braising pans; through a detachable, semi-rigid, flexible, reinforced, multi-ply silicone drain tube assembly is provided. The drain tube assembly includes a male or female threaded fitting at one end in accordance with industry standard ½″ to 2″ or other international threaded fitting sizes. The drain tube assembly may include an easy cam disconnect connection. The fryer includes a cam nipple installed on the drain valve and the drain tube assembly includes a corresponding cam fitting. The drain tube may include various lengths, diameters, thread fittings, and shapes to meet the needs of the foodservice operator.

### CROSS REFERENCE TO RELATED APPLICATIONS

This application claims the benefit of U.S. provisional patent application No. 63/646,116 filed May 13, 2024, which is fully incorporated herein.

### FIELD OF THE INVENTION

This invention relates generally to fryers and, more particularly, to the draining of edible cooking oil from fryers. However, this invention can be beneficial to other commercial cooking equipment such as kettles, steamers, braising pans, and the like.

### BACKGROUND OF THE INVENTION

Fryers are extensively used in the food industry to cook various foods and render them flavorful, colorful, and digestible. One common type of fryer is a deep fat fryer, which includes a heated vessel of edible cooking oil in which food items are placed for cooking. Depending on the application, deep fat fryers are sized to contain anywhere between one to thousands of gallons of heated cooking oil. Food products are cooked by being immersed in the cooking oil for a period of time before being removed. The cooking oil is typically heated in the vessel to a temperature between about 250° Fahrenheit (F) and about 375° F. (about 121° C. and about 190° C.), and in some cases the cooking oil is heated to temperatures as high as 425° F.

Over time, as food items are continually introduced into the fryer and cooked, the cooking oil breaks down and becomes contaminated with particulate such as suspended food particles. More particularly, starches and proteins break down the cooking oil through chemical reaction with oxidation, polymerization, hydration, and other similar compounds that are catalysts in the degradation process of the cooking oil. One example of a contributor to the alteration and degradation of the cooking oil is food particles that become dislodged from food during the cooking process and thereafter remain in the oil as particulate. Water and fats that are extracted from the food during the cooking process and remain in the oil, and any other contaminants such as free fatty acids, are other examples of possible contaminants that may alter the cooking characteristics of the cooking oil.

In foodservice operations using commercial cooking equipment, such as deep fat fryers, it is essential to drain and filter the cooking oil regularly to remove contaminants or to completely discard the oil. This task requires operators to install a drain tube daily, or several times per day, per fryer. In kitchens with multiple fryers, ranging from one to five typically, and in some cases, as many as eleven, managing these drain tubes becomes a critical operational challenge.

Fryers without an integrated filtration system may feature a ball drain valve with either a female or male threaded fitting to which a threaded drain tube may be attached to facilitate the drainage of oil from the fry tank into a filter bin or discard container. Standard metal drain tubes are made from steel or aluminum and may feature various thread sizes from ½″ NPT (National Pipe Thread) to 2″ NPT, or may include international threads. However, metal drain tubes can become lost or damaged, their threads rendered non-functional due to mishandling, leading to necessary and oftentimes frequent replacements. Over time, the threads on these aluminum tubes wear out, making them unusable and posing a risk of dislodging during use, potentially causing hot oil to splash and burn the operator. Additionally, metal flakes from the degraded threads can mix with the debris in the filter bin, with some small enough to evade filtration and circulate back into the fryer. The rigidity of metal tubes and their propensity to act as heat sinks, retaining heat for extended periods, complicates their use as well. For example, the rigidity of metal drain tubes may hinder the movement of portable filter machines or containers for safe positioning under the drain tube.

In view of the above, there is an increasing need in the industry for a flexible, semi-rigid drain tube that both minimizes heat retention and dissipates heat rapidly, substantially reducing the burn risk and facilitating safer, more efficient handling across multiple fryers and other commercial appliances that need to be drained to thereby enhance safety and increase operational efficiency in kitchen environments.

### SUMMARY OF THE INVENTION

According to embodiments of the present invention, a method for effectively draining edible cooking oil at up to 350° F. (170° C.) and other by-products of the frying process from commercial counter model, free standing or in-battery deep fat fryers, and other commercial cooking equipment such as, griddles, combi ovens, pasta cookers, and braising pans, through a detachable, semi-rigid, flexible, reinforced, multi-ply food safe silicone drain tube assembly is provided. Compared to traditional aluminum, mild steel, black iron, or stainless steel pipe, the drain tube of the drain tube assembly is cooler to the touch. The drain tube may be available with various male or female threaded fittings at one end, with industry standard ½″ to 2″ or other international threaded fittings.

In another embodiment, the drain tube assembly may be provided with a quick connection assembly in the form of a cam disconnect connection with Polytetrafluoroethylene (PTFE), Viton, or Silicone sealing gasket. In that regard, a cam nipple may be installed on the drain valve of a fryer, and the flexible silicone drain tube may be easily attached to the female matching cam fitting.

The drain tube assembly may include various lengths, diameters, thread fittings, and shapes to meet the needs of the foodservice operator, and to provide a drain tube that has reduced splash and spatter from traditional drain tubes.

In another embodiment of the invention, a drain tube assembly is provided. The drain tube assembly includes a fitting with a threaded end and an opposite barb end and a drain tube that extends a length between a first end and an opposite second end, with the first end of the drain tube being secured to the barb end of the fitting with a clamp. The drain tube comprises a multi-ply, reinforced silicone tube being configured to convey edible cooking oil at up to 350° F. (170° C.).

According to another embodiment of the invention, a fryer is provided. The fryer includes a fry pot configured to hold a volume of edible cooking oil and a drain line including an integral drain valve with a male or female threaded end, with the drain line being in fluid communication with the fry pot of the fryer. The fryer includes the drain tube assembly of any embodiment described above. The threaded end of the fitting of the drain tube assembly is threadedly connected to the female threaded end of the drain valve of the fryer to fluidly connect the drain tube assembly to the fryer to drain edible cooking oil from the fry pot.

In yet another embodiment of the invention, a quick connect assembly configured to fluidly connect the drain tube assembly to the fryer is provided. The quick connect assembly includes a male quick-connect fitting connected to the female threaded end of the drain valve of the fryer and a female quick-connect fitting connected to the threaded end of the drain tube fitting. The male quick-connect fitting and the female quick connect fitting may be connectable in a tool-less manner, for example. In one embodiment, the quick connect assembly is a camlock fitting with the male quick-connect fitting being a cam nipple and the female quick-connect fitting being a cam coupler.

In another embodiment of the invention, a fryer system is provided. The fryer system includes the fryer of any embodiment described above and a filter bin or discard container configured to receive edible cooking oil drained from the fry pot through the drain tube.

Various additional features and advantages of the invention will become more apparent to those of ordinary skill in the art upon review of the following detailed description of one or more illustrative embodiments taken in conjunction with the accompanying drawings.

### BRIEF DESCRIPTION OF THE DRAWINGS

The accompanying drawings, which are incorporated in and constitute a part of this specification, illustrate one or more embodiments of the invention and, together with the general description given above and the detailed description given below, serve to describe the one or more embodiments of the invention.

FIG. 1 is a schematic side view of an exemplary fryer system including a fryer equipped with a drain tube assembly that is angled according to an embodiment of the invention.

FIG. 1A is a schematic side view of the fryer system illustrating the fryer equipped with a drain tube assembly that is straight according to another embodiment of the invention.

FIG. 1B is a schematic side view of the fryer system illustrating the fryer equipped with a drain tube assembly that is extra long to reduce splash and splatter according to another embodiment of the invention.

FIG. 1C is a schematic side view of the fryer system illustrating the fryer equipped with a drain tube assembly that is curved demonstrating how the drain tube may be designed to fit any application according to another embodiment of the invention.

FIG. 2 is a perspective view of the drain tube assembly of FIG. 1.

FIGS. 3A and 3B are perspective views of a drain tube assembly according to another embodiment of the invention with various diameters for example a 1¼ inch ball valve connection, termination in a bulbous 2 inch diameter exit, a design that effectively reduces the flow exit velocity of oil to reduce splatter.

FIG. 4 is a schematic side view of an exemplary fryer system including a fryer equipped with a drain tube assembly according to another embodiment of the invention.

FIG. 5 is a schematic cross-sectional view of the drain tube assembly of FIG. 4, illustrating the drain tube assembly partially disassembled.

FIG. 6 is a perspective view of the drain tube of FIGS. 4 and 5, illustrating the drain tube disconnected from a cam nipple of the fryer.

FIG. 7 is a view similar to FIG. 6, illustrating the drain tube connected to the cam nipple of the fryer.

FIG. 8 is a schematic side view of an exemplary fryer system including a tabletop fryer equipped with a drain tube assembly according to another embodiment of the invention.

### DETAILED DESCRIPTION OF THE INVENTION

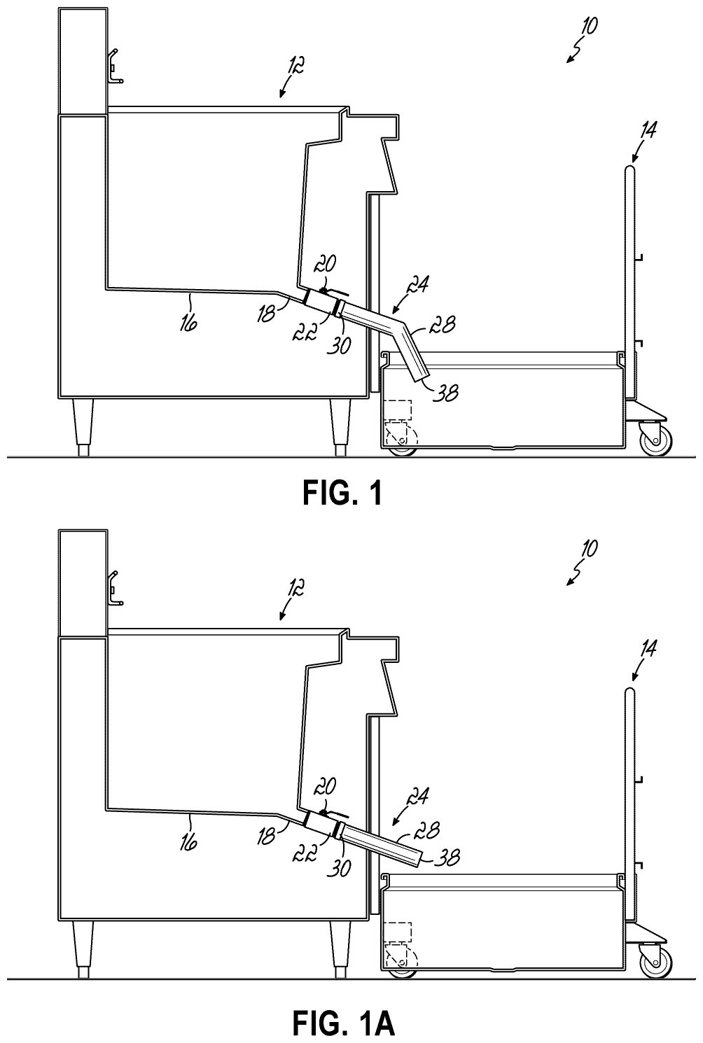

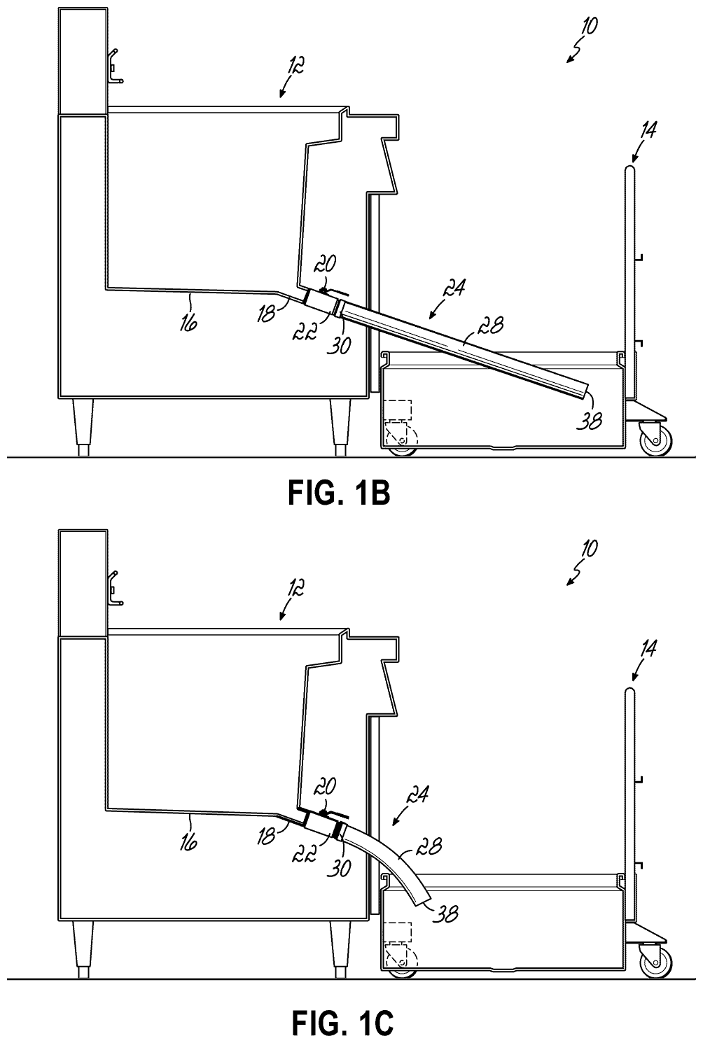

Referring now to the drawings and to FIG. 1 in particular, a fryer system 10 is shown, including an exemplary fryer 12 and a container 14, such as a portable filter machine or discard container. While aspects of the invention are shown and described in the context of one or more exemplary fryer systems, it will be understood that the inventive concepts of the present invention may be implemented with different fryers and fryer systems, or other commercial cooking equipment that needs to be drained, without departing from the scope of the invention. Accordingly, aspects of the present invention are not limited to the specific embodiment shown and described herein, but encompass a wide range of fryers and fryer systems in general.

The exemplary fryer 12 of the fryer system 10 may be a free standing or countertop deep fat fryer having a chamber 16, otherwise referred to as a fry pot, configured to hold a volume of cooking oil for cooking comestibles. The fry pot 16 of the fryer 12 is configured to accommodate a food basket for cooking comestibles in the cooking oil. In that regard, the fryer 12 includes a heat source, which may be located within the fry pot 16 and below the surface of cooking oil, for heating the cooking oil. While not shown, the fryer 12 may include various other components known in the art, such as a crumb basket and a filter assembly, for example. The exemplary discard or filter container 14 of the fryer system 10 may be a portable, wheeled container configured to receive a quantity of edible cooking oil from the fryer 12, as will be described in further detail below.

As shown in FIG. 1, the fryer 12 includes a drain line 18 through which the edible cooking oil may be drained from the fryer 12 and into, for example, the container 14. Specifically, the edible cooking oil may gravity drain from the fryer 12 into the container 14, which is generally positioned adjacent to the fryer 12 and beneath the drain line 18 to collect the oil. The drain line 18 includes a drain valve 20, such as a ball valve, which may be operated to selectively drain the cooking oil from the fryer 12. In that regard, the fry pot 16 is in communication with the drain valve 20 via the drain line 18. The drain valve 20 includes a female threaded end 22 (i.e., an internally threaded end) that is configured to receive a detachable drain tube assembly 24 according to embodiments of the present invention, as will be described in further detail below. It will be understood that the fryer 12 may be equipped with any other type of valve suitable for stopping or allowing the flow of cooking oil through the drain line 18, such as a butterfly valve, gate valve, or diaphragm valve, for example. The drain valve 20 may be threaded onto or welded to the drain line 18, for example.

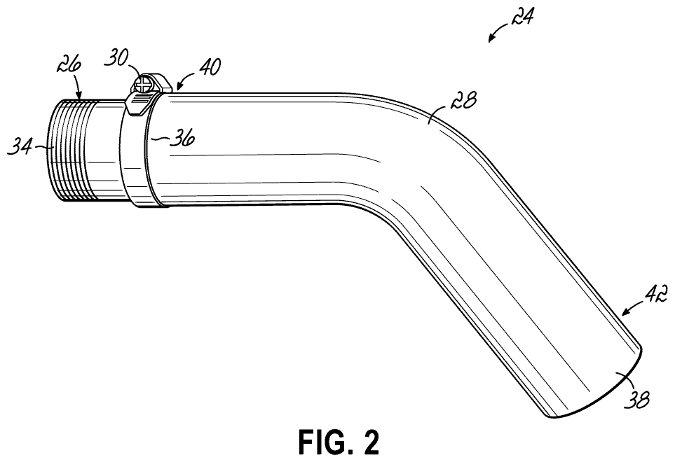

With continued reference to FIG. 1, the drain tube assembly 24 is configured to be threaded into the female threaded end 22 of the drain valve 20 to secure the drain tube assembly 24 to the fryer 12 to thereby direct the flow of cooking oil from the fryer 12 into the container 14. As shown in FIG. 2, the drain tube assembly 24 includes a fitting 26 and a drain tube 28 secured to the fitting 26 with a clamp 30. The fitting 26 may be made of metal such as stainless steel or any known high temperature plastic. In the embodiment shown, the fitting 26 may be a hose barb, including a barb end 32 (FIG. 5) and an opposite, threaded end 34. In some embodiments not shown the barb end 32 may not be threaded. In the embodiment shown, the threaded end 34 is externally threaded in the form of a NPT fitting or threaded pipe nipple. The threaded end 34 of the fitting 26 may have a diameter within a range of ½ inch to 2 inches, for example. As best seen in FIG. 2, the drain tube 28 is a silicone drain tube that extends a length between a first end 36 and an opposite second end 38. The drain tube 28 may have any length suitable to position the second end 38 of the drain tube 28 within or just above the container 14 to reduce or prevent splashing of oil during draining operations. For example, the drain tube 28 may have a length of up to 36 inches or more. The clamp 30 may be a band clamp, for example.

Referring now to FIGS. 2 and 5, the barb end 32 of the fitting 26, which may be threaded, smooth, or feature several annular ridges, is received into the first end 36 of the drain tube 28. In that regard, the barb end 32 of the fitting 26 is partially enveloped by the first end 36 of the drain tube 28, which fits snugly over the fitting 26. Positioned about the junction where the first end 36 of the drain tube 28 meets the fitting 26 is the clamp 30. The clamp 30 is tightened to ensure a leak-proof seal between the drain tube 28 and the fitting 26. The clamp 30, which can be adjusted with a screwdriver or nut driver, is tightened to maintain a secure fit without compressing the drain tube 28 excessively, thus avoiding any damage to the drain tube 28. The externally threaded end 34 protrudes from the first end 36 of the drain tube 28, as shown in FIG. 2, for example. While one type of clamp 30 is shown and described, other types of clamps are within the scope of the present invention, such as a strap clamps or pipe clamp, for example.

To connect the drain tube assembly 24 to the drain line 18 of the fryer 12, the externally threaded end 34 of the fitting 26, being a male threaded section, is configured to be threaded into the female threaded end 22 of the drain valve 20 to form a fluid-tight connection therebetween. The connection between the fitting 26 of the drain tube assembly 24 and the drain valve 20 may be made by hand or with a tool. In either case, the connection between the fitting 26 of the drain tube assembly 24 and the drain valve 20 is fluid-tight, ensuring the transfer of cooking oil from the drain line 18 through the drain tube assembly 24 without any leakage at the joint between the fitting 26 and the drain valve 20.

As briefly described above, the drain tube 28 of the drain tube assembly 24 is made of silicone. Specifically, the drain tube 28 is a multi-ply, reinforced silicone tube that is food safe in direct contact with food, having a semi-rigid, flexible construction. The drain tube 28 includes multiple layers or “plies,” such as two to five plies, for example. Each ply includes reinforcement materials like polyester, fiberglass, or nylon fabric embedded within the silicone that forms the drain tube 28. In that regard, the drain tube 28 includes an inner layer that is configured to directly contact the conveyed cooking oil and an outer, external layer. Between the inner layer and the outer layer are the reinforcement layers or plies. The reinforcement layers enhance the mechanical strength, pressure and heat resistance of the drain tube 28. The outer layer of the drain tube 28 may serve as a protection against environmental factors like physical abrasion and may be colored or marked for easy identification.

Despite the reinforcement layers, the drain tube 28 retains essential flexibility, allowing it to be manipulated before, during, and after installation to the fryer 12. For instance, once installed to the fryer 12, the drain tube 28 may be bent or otherwise manipulated to move the container 14 in place beneath the fryer 12 as well as position the drain tube 28 optimally for draining operations. This flexibility contrasts with rigid metal drain tubes, which typically must be installed after the container 14 is positioned relative to the fryer 12. The multi-ply configuration of the drain tube 28 maintains the shape of the drain tube 28, particularly under the varying temperatures of the conveyed cooking oil, which may be up to 350° F. or more and include sediment from the fryer 12. As a result of the silicone construction, the drain tube 28 cools quickly after prolonged exposure from draining high temperature cooking oil.

Although the drain tube 28 configuration is flexible and semi-rigid, the drain tube 28 includes a rest shape, which is the shape to which the drain tube 28 returns after being manipulated. In the embodiment shown in FIGS. 1 and 2, the drain tube 28 includes a bent rest shape, having a first leg portion 40 being angled relative to a second leg portion 42 of the drain tube 28 to define a drain tube angle. The drain tube angle may be any angle, and in this example, may be about 135° when the drain tube 28 is in the rest shape. In this context, “about” is intended to mean +/−5°. The first and second leg portions 40, 42 may each be any desired length including a length of 10 inches or longer, for example.

Other drain tube angles, lengths, and rest shapes of the drain tube 28 suitable to position the second end 38 of the drain tube 28 within or just above the container 14 to minimize splashing of the cooking oil during draining operations are within the scope of the invention. For example, as shown in FIG. 1A, the drain tube 28 may have a generally straight rest shape (i.e. no drain tube angle) and a length configured to position the second end 38 of the drain tube 28 just above the container 14. As shown in FIG. 1B, the drain tube 28 may have a generally straight rest shape and a length configured to position the second end 38 of the drain tube 28 within the container 14. As shown in FIG. 1C, the drain tube 28 may have a smoothly curved or arcuate rest shape and a length configured to position the second end 38 of the drain tube 28 within the container 14. The drain tube 28 shown in FIG. 1C is curved in a downward direction such that the second end 38 of the drain tube 28 generally faces the bottom of the container 14 to reduce splashing of the oil during draining operations. The curvature of the drain tube 28 may include any design radius to meet the angular need of a given ball drain valve angle.

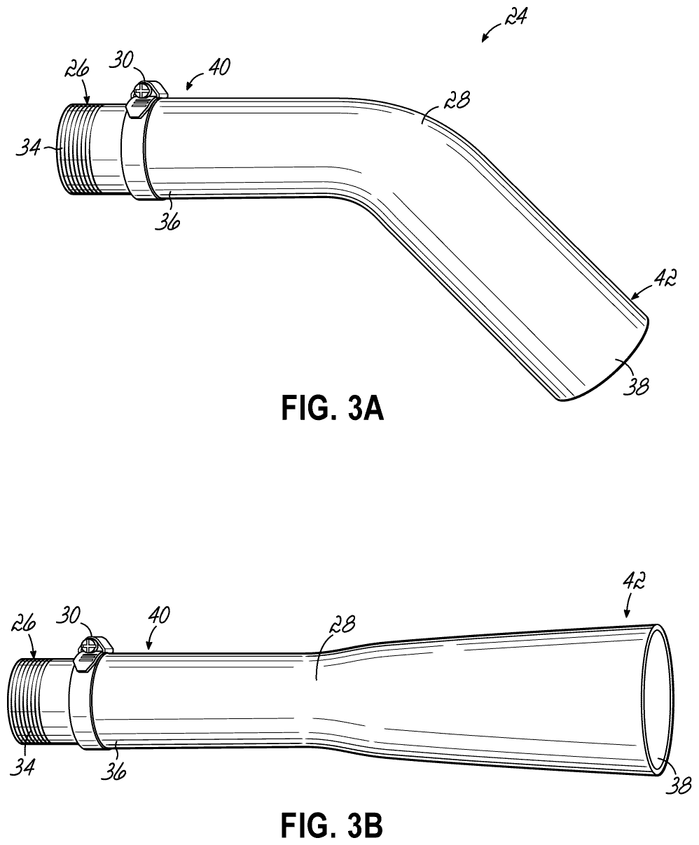

FIGS. 3A and 3B show the drain tube 28 of the drain tube assembly 24 according to an alternative embodiment of the invention. As shown, the second leg 42 portion of the drain tube 28 includes a larger diameter compared to the diameter of the first leg portion 40 of the drain tube 28. In particular, the diameter of the second leg portion 42 may gradually increase along a length of the second leg portion 42 from the first leg portion 40 to the second end 38. The second leg portion 42 may be generally conical (truncated) in shape, with the second end 38 forming the base of the cone. For example, the first leg portion 40 may have an inner diameter of 1.5 inches and the second leg portion 42 may have an inner diameter of 2 inches. The increase in diameter from the first leg portion 40 to the second leg portion 42 of the drain tube 28 reduces flow velocity and the splashing and splattering of cooking oil as it is drained into the container 14.

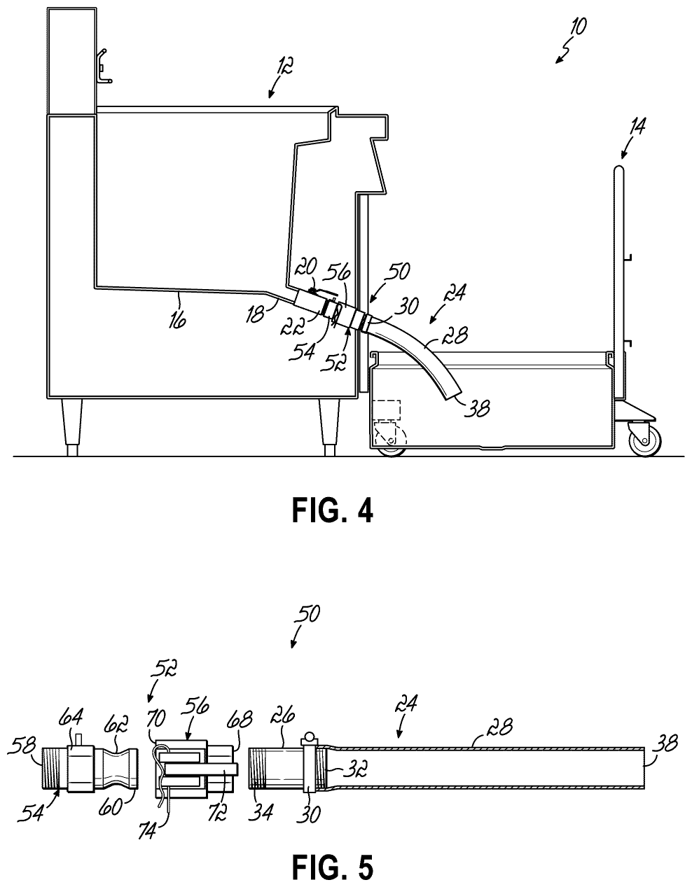

Referring now to FIGS. 4-7, where like reference numerals represent like features compared to the embodiment of the drain tube assembly 24 described above with respect to FIGS. 1-3B, a quick connect drain tube assembly 50 is shown according to another embodiment of the present invention. The primary difference between the quick connect drain tube assembly 50 of this embodiment and the drain tube assembly 24 of the previous embodiment is the use of a quick connect assembly 52 to attach the drain tube assembly 24 to the fryer 12 in a tool-less manner. In particular, the quick-connect assembly 52 includes a male quick-connect fitting 54 and a female quick-connect fitting 56 that may be coupled together and decoupled in a tool-less manner. In the embodiment shown, the quick connect assembly 52 may be in the form of a stainless steel or aluminum camlock fitting, otherwise referred to as a cam and groove coupling. However, other suitable quick connect assemblies may be used, such as a push-to-connect fitting, twist/lock coupling, quick-disconnect coupling, or hydraulic coupling, for example.

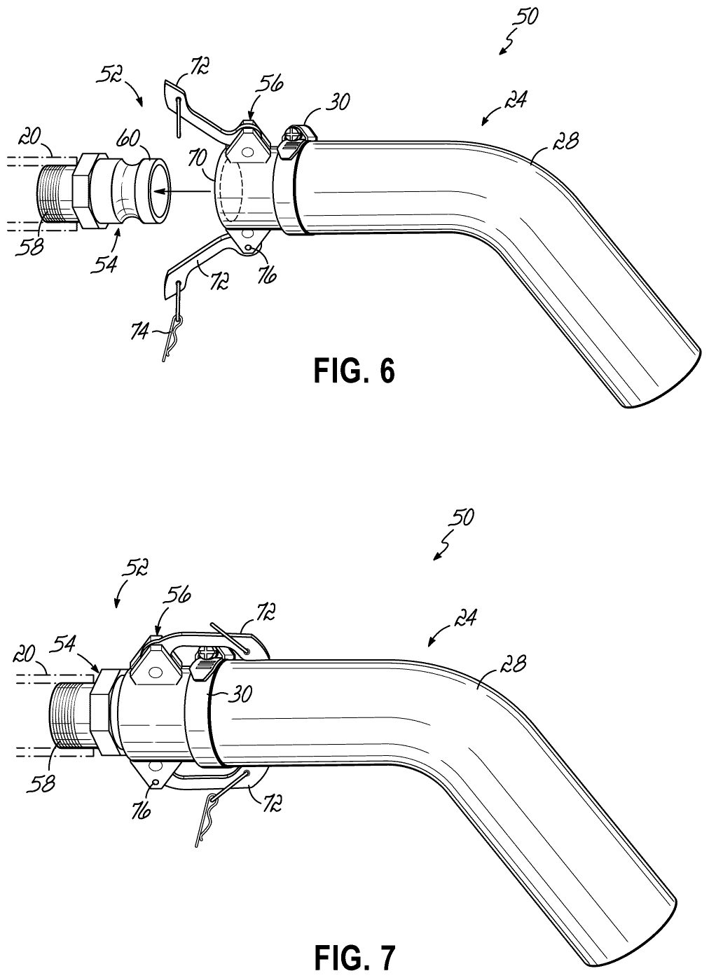

As shown in FIGS. 5 and 6, the male fitting 54 of the quick-connect assembly 52, which otherwise may be referred to as the cam nipple or adapter, includes a straight, tubular body having a threaded end 58 and an opposite grooved end 60. The grooved end 60 is configured to be received into the corresponding female fitting 56 and includes an annular groove 62. The threaded end 58 is externally threaded in the form of a NPT (National Pipe Thread) fitting or threaded pipe nipple. The threaded end 58 of the male fitting 54 may have a diameter within a range of ½ inch to 2 inches, for example. The externally threaded end 58 of the male fitting 54 is a male threaded section that is configured to be threaded into the female threaded end 22 of the drain valve 20 of the fryer 12 to form a fluid-tight seal therebetween. In that regard, the connection between the male fitting 54 and the drain valve 20 is fluid-tight. The male fitting 54 may include a collar 64, such as a hex collar, to facilitate tightening of the male fitting 54 to the drain valve 20 with a tool.

With continued reference to FIGS. 5 and 6, the female fitting 56 of the quick-connect assembly 52, which otherwise may be referred to as the cam coupler, includes a straight, tubular body with a female threaded end 68 and an opposite coupler end 70. The coupler end 70 is configured to receive the grooved end 60 of the male fitting 54. The female threaded end 68 is internally threaded and configured to receive the externally threaded end 34 of the fitting 26 of the drain tube assembly 24. In that regard, the externally threaded end 34 of the fitting 26 is configured to be threaded into the female threaded end 68 of the female fitting 56 to fluidly connect the female fitting 56 to the fitting 26 of the drain tube assembly 24. The connection between the female fitting 56 and the fitting 26 of the drain tube assembly 24 is fluid-tight. To that end, the female fitting 56 may remain with the drain tube assembly 24 when the drain tube assembly 24 is disconnected from the fryer 12, for example.

The female fitting 56 of the quick-connect assembly 52 includes a pair of cam arms 72 movable between a release position, as shown in FIG. 6, and an coupled position, as shown in FIG. 7. The interior of the coupler end 70 of the female fitting 56 defines a socket configured to receive the grooved end 60 of the male fitting 54 of the quick-connect assembly 52. In particular, the interior of the female fitting 56 includes a gasket which ensures a tight seal when the grooved end 60 of the male fitting 54 is fully received into the coupler end 70 of the female fitting 56. When the grooved end 60 of the male fitting 54 is fully received into the coupler end 70 of the female fitting 56, the annular groove 62 of the male fitting 54 aligns with the cam arms 72. Each cam arm 72 includes a cam configured to engage the annular groove 62 to draw the male fitting 54 into the female fitting 56 for connection. That is, as the cam arms 72 are moved from the released position to the coupled position, each cam engages the annular groove 62 on the male fitting 54 to pull the grooved end 60 of the male fitting 54 deeper into the female fitting 56, tightening the connection therebetween. As the male fitting 54 is pulled snugly into the female fitting 56, the gasket located inside female fitting 56 is compressed, creating a fluid-tight seal between the male fitting 54 and the female fitting 56. The gasket may be made of a flexible compound that is chemical resistant and capable of withstanding up to 400° F. (204° C.) hot edible oil or another flexible, durable material, such as silicone, PTFE, or VITON, for example, which is suitable for providing a tight seal and withstanding repeated contact with hot oil. Each cam arm 72 may include a safety or cotter pin 74 used to lock each cam arm 72 in the coupled position to prevent inadvertent decoupling of the drain tube assembly 24 from the drain valve 20. The safety pin 74 fits through an opening 76, as shown in FIG. 7, when the cam arm 72 is in the coupled/locked position.

As briefly described above, the quick-connect assembly 52 allows for the tool-less assembly and disassembly of the drain tube assembly 24 to one or more fryer drain lines 18. In that regard, an operator may quickly, without tools, attach the drain tube assembly 24 to a first fryer 12 to drain the cooking oil therefrom during a first draining or filtering operation. The operator may then quickly disconnect, by hand, the drain tube assembly 24 from the first fryer 12 and proceed to a next fryer 12 where the drain tube assembly 24 may be again attached in a tool-less manner for a second draining operation. This process may be repeated for each successive fryer 12 without having to thread the drain tube onto the fryer 12.

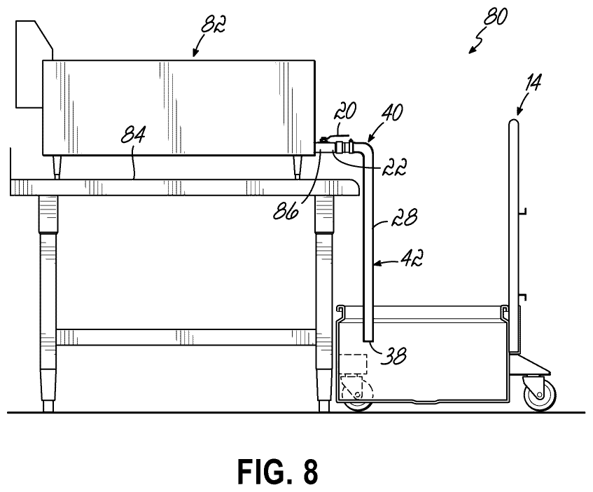

Referring now to FIG. 8, where like reference numerals represent like features compared to the embodiments of the drain tube assemblies 24, 50 described above with respect to FIGS. 1-7, a fryer system 80 is shown including a countertop fryer 82 equipped with the drain tube assembly 24 according to another embodiment of the present invention. As shown, the fryer 82 is positioned atop a tabletop 84 and includes a drain line 86 through which the edible cooking oil may be drained from the fryer 82 and into a filter or discard container 14. The edible cooking oil may gravity drained from the fryer 82 into the container 14, for example. The drain line 86 includes a drain valve 20 which may be operated to selectively drain the cooking oil from the fryer 82.

The drain tube assembly 24 may be threadedly connected to the female threaded end 22 of the drain valve 20 as described above. In this or other embodiments, the fitting 26 of the drain tube assembly 24 may be in the form of a swivel fitting for enhanced flexibility and ease of installation of the drain line assembly 24 to the fryer 82. In either case, in the embodiment shown in FIG. 8, the drain tube 28 features a bent rest shape with a drain tube angle of about 90°. The term “about” as used herein is intended to mean +/−5°. As shown, the first leg portion 40 is shorter in length compared to the second leg portion 42 to accommodate for a height of the tabletop 84 above the ground on which the container 14 is located, for example. The drain tube 28 may be bent in a downward direction such that the second end 38 of the drain tube 28 generally faces the bottom of the container 14 to reduce splashing of the oil during draining operations.

While the various principles of the invention have been illustrated by way of describing various exemplary embodiments, and while such embodiments have been described in considerable detail, there is no intention to restrict, or in any way limit, the scope of the appended claims to such detail. Additional advantages and modifications will readily appear to those skilled in the art. Further, various changes could be made in the above-described aspects and exemplary embodiments without departing from the scope of the invention, and it is intended that all matter contained in the above description shall be interpreted as illustrative and not in a limiting sense.

What is claimed is:

1. A method of draining edible cooking oil at a temperature of up to 350° F. and sediment from commercial free standing, in-battery, counter model deep fat fryers, free standing, multiple fryers, or any other commercial appliance such as a kettle, steamer, braising pan, or combi oven, the method comprising:
providing a detachable, semi-rigid, flexible, reinforced silicone drain tube having two to five plies,
attaching the drain tube to either the commercial free standing deep fat fryer, in-battery deep fat fryer, counter model deep fat fryer, or any other commercial appliance such as a kettle, steamer, braising pan, or combi oven.

2. The method of claim 1, wherein the drain tube is cooler to the touch than traditional aluminum, mild steel, black iron or stainless steel pipe.

3. The method of claim 1, wherein the drain tube includes a threaded fitting at one end.

4. The method of claim 1, wherein the threaded fitting is a stainless steel pipe nipple or other durable food grade material such as PPS (polyphenol sulfide) or Nylon 66 with the male or female threaded end and available in various lengths.

5. The method of claim 3, wherein the threaded fitting is available in various threaded attachment male and female thread types from ½″ to 2″ diameters.

6. The method of claim 3, wherein the drain tube is attached to the threaded fitting with a durable stainless clamping device.

7. The method of claim 1, wherein the drain tube includes male or female threads at one end to be used with industry standard one-half to two inch diameter fittings.

8. The method of claim 1, wherein the drain tube is offered in various lengths and shapes to meet the needs of the food service establishment.

9. The method of claim 1, wherein the drain tube is attachable to the fryer using a quick connect assembly.

10. The method of claim 9, wherein the quick connect assembly includes a threaded cam nipple and cam quick connect.

11. A drain tube assembly, comprising:
a fitting including a threaded end and an opposite barb end; and
a drain tube that extends a length between a first end and an opposite second end, the first end of the drain tube being secured to the barb end of the fitting with a clamp, the drain tube comprising a multi-ply, reinforced silicone tube being configured to convey edible cooking oil at up to 350° F. (170° C.).

12. A fryer, comprising:
a fry pot configured to hold a volume of edible cooking oil;
a drain line including an integral drain valve with a male or female threaded end, the drain line being in fluid communication with the fry pot of the fryer; and
the drain tube assembly of claim 11, the threaded end of the fitting being threadedly connected to the female threaded end of the drain valve to fluidly connect the drain tube assembly to the fryer to drain edible cooking oil from the fry pot.

13. The fryer of claim 12, further comprising a quick connect assembly configured to fluidly connect the drain tube assembly to the fryer, the quick connect assembly including a male quick-connect fitting connected to the female threaded end of the drain valve of the fryer and a female quick-connect fitting connected to the threaded end of the drain tube fitting.

14. The fryer of claim 13, wherein the male quick-connect fitting and the female quick connect fitting are connectable in a tool-less manner.

15. The fryer of claim 13, wherein the quick connect assembly is a camlock fitting with the male quick-connect fitting being a cam nipple and the female quick-connect fitting being a cam coupler.

16. A fryer system, comprising:
the fryer of claim 12; and
a filter bin or discard container configured to receive edible cooking oil drained from the fry pot through the drain tube.
